(19) United States
(12) Patent Application Publication
(10) Pub. No.: US 2007/0040791 A1
(43) Pub. Date: Feb. 22, 2007

(54) Overdrive source driver for liquid crystal display

(76) Inventor: Feng-Ting Pai, Hsinchu City (TW)

Correspondence Address: RABIN & Berdo, PC, 1101 14TH STREET, NW, SUITE 500, WASHINGTON, DC, 20005, US

(21) Appl. No.: 11/198,156

(22) Filed: Aug. 8, 2005

(51) Int. Cl. G09G 3/36

(52) U.S. Cl. 345/100

(57) ABSTRACT

An overdrive device for a liquid crystal display, providing a 2-level overdrive signal, reducing a response time of the liquid crystal display, comprises a first multiplexer, a source driver, and a second multiplexer. The first multiplexer receives first and second reference voltages and provides the first or second reference voltage as a first level output signal according to a polarity signal. The source driver provides a second level output signal according to the polarity signal. The second multiplexer receives the first and second level output signals and provides the first or second level output signal as the overdrive signal according to a load signal.

### BACKGROUND

The invention relates to a source driver for a liquid crystal display and, in particular, to an overdrive source driver reducing response time of a liquid crystal display.

FIG. 1 is a schematic diagram of a conventional TFT-LCD driving system. The conventional TFT-LCD driving system comprises a pixel array 110, a plurality of source drivers 120 connected in series, a timing controller 130, and a reference voltage generator 140. The source drivers 120 receive data, load, and polarity signals from the timing controller 130 and are controlled thereby. Each source driver 120 loads a reference voltage corresponding to the received data signal according to the load signal Load and outputs the reference voltage to the pixel array 110.

FIG. 2 is a block diagram of a conventional source driver 120 shown in FIG. 1. The conventional source driver 120 comprises a shift register 121, a register 123, a latch 125, and a D/A converter 127. The register 123 is coupled to the shift register 121 and receives a data signal DATA. The latch 125 is coupled to the register 123. The D/A converter 127 is coupled to the latch 125 and receives a polarity signal POL, a load signal Load and a reference voltage corresponding to the data signal DATA. To reduce power consumption of a conventional source driver, the conventional source driver typically has limited driving capability. As a result, it takes time to settle an output voltage of the conventional source driver, thus impacting response time of a conventional liquid crystal display.

### SUMMARY

An embodiment of an overdrive device for a liquid crystal display, providing a 2-level overdrive signal reducing response time of the liquid crystal display, comprises a first multiplexer and a second multiplexer. The first multiplexer receives first and second reference voltages and provides the first or second reference voltage as a first level output signal according to a polarity signal. The second multiplexer is coupled to a source driver and receives the first level output signal and a second level output signal from the source driver and provides the first or second level output signal as the overdrive signal according to a load signal.

An embodiment of an overdrive source driver for a liquid crystal display comprises a shift register, a register, a latch, a D/A converter, and a first multiplexer. The register is coupled to the shift register and receives a gray level signal. The latch is coupled to the register and latches the gray level signal. The D/A converter is coupled to the latch. The D/A converter receives a polarity signal, a load signal and a gamma voltage and converts the gray level gray level to a gray level voltage corresponding to the gray level signal. The first multiplexer receives an output signal of the D/A converter and a variable external reference voltage and selects the output signal of the D/A converter or the variable external reference voltage as an overdrive output signal according to the load signal.

An embodiment of an overdrive system for a liquid crystal display comprises a plurality of the disclosed overdrive source drivers connected in series, and first and second external multiplexers. Each overdrive source driver is coupled to the liquid crystal display. The first and second external multiplexers are respectively coupled to first and last overdrive source drivers. The first and second external multiplexers both receive first and second reference voltages and provide a variable external reference voltage to the first and last overdrive source drivers.

Also provided is a liquid crystal display comprising the disclosed overdrive system.

### BRIEF DESCRIPTION OF THE DRAWINGS

FIG. 1 is a schematic diagram of a conventional TFT-LCD driving system.

FIG. 2 is a block diagram of a conventional source driver shown in FIG. 1.

FIG. 3 is a schematic diagram of a 2-level source driver according to an embodiment of the invention.

FIG. 4A is an exemplary output waveform of a 2-level source driver according to an embodiment of the invention.

FIG. 4B is another exemplary output waveform of a 2-level source driver according to an embodiment of the invention.

FIG. 5 is a schematic diagram of a 2-levle source driver according to another embodiment of the invention.

FIG. 6A is a schematic diagram of a liquid crystal display comprising an overdrive system according to an embodiment of the invention.

FIG. 6B is a schematic diagram of a liquid crystal display comprising a variation of the overdrive system in FIG. 6A.

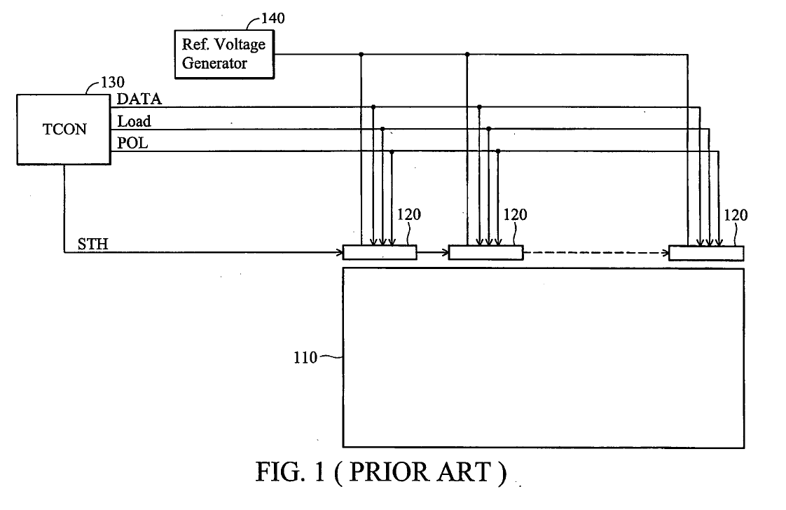

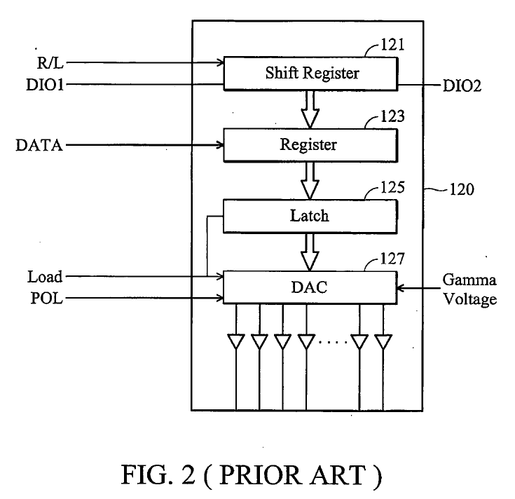

### DETAILED DESCRIPTION

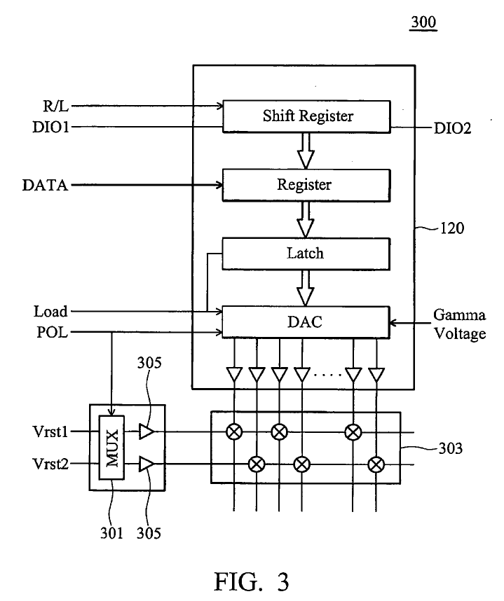

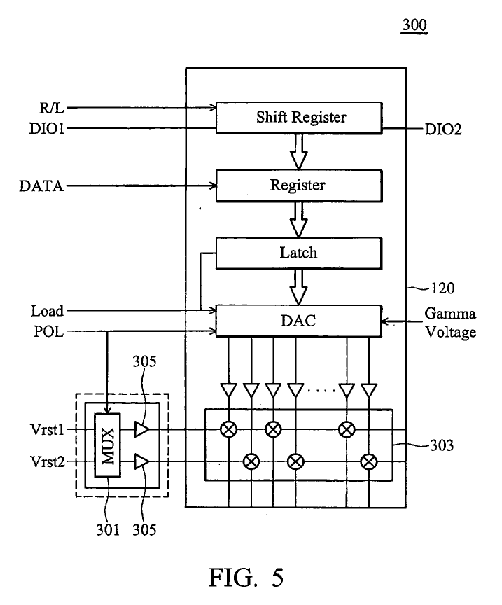

FIG. 3 is a schematic diagram of a 2-level source driver 300 according to an embodiment of the invention. The 2-level source driver 300 provides a 2-level output signal, reducing response time of a liquid crystal display. The 2-level source driver 300 comprises a conventional source driver 102, a multiplexer 301 and an output circuit 303. The multiplexer 301 receives first and second reference voltages Vᵣₛₜ₁/Vᵣₛₜ₂ and provides the first or second reference voltage Vᵣₛₜ₁/Vᵣₛₜ₂ as a first level output signal according to a polarity signal POL. The output circuit 303 successively outputs the first or second reference voltages Vᵣₛₜ₁/Vᵣₛₜ₂ as the first level output signal and a gray level voltage as the second level output signal to a pixel array (not shown in FIG. 3). In one embodiment, the output circuit 303 may be separated from the conventional source driver 102, as shown in FIG. 3. In another embodiment, the output circuit 303 is integrated into the conventional source driver 102, as shown in FIG. 5. In addition, the 2-level source driver 300 may further comprise a buffer 305 coupled between the multiplexer 301 and the output circuit 303. The buffer 305 improves driving capability of the multiplexer 301.

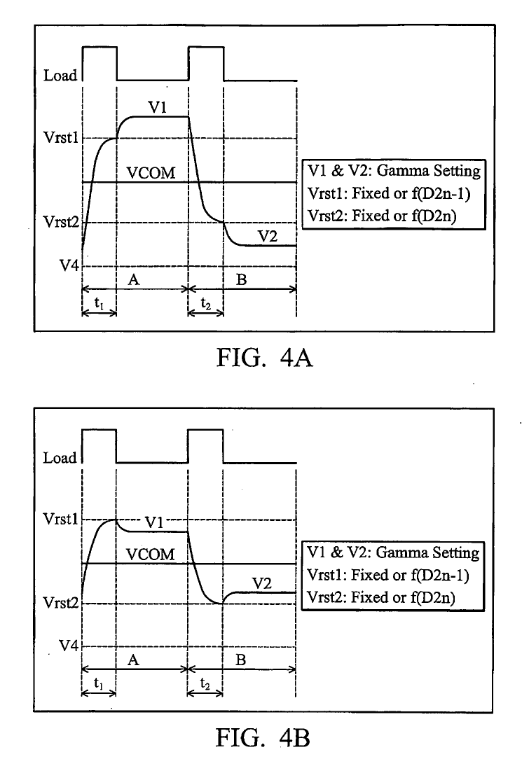

FIG. 4A is an exemplary output waveform of a 2-level source driver 300 according to an embodiment of the invention. During period A, the multiplexer 301 in the 2-level source driver 300 receives the polarity signal POL and first and second reference voltages Vᵣₛₜ₁/Vᵣₛₜ₂. The first reference voltage Vᵣₛₜ₁ is selected as a first level output signal according to the polarity signal POL. The register 123 in the 2-level source driver 300 receives a gray level signal. The D/A converter 127 receives a load signal LOAD, a polarity signal POL, and a gamma voltage and converts the gray level signal to a corresponding gray level voltage V1. The gray level voltage V1 is a second level output signal during the period A. In FIG. 4A, the first level output signal Vᵣₛₜ₁ is lower than the second level output signal V1. The output circuit 303 receives the first and second level output signals Vᵣₛₜ₁ and V1. When the load signal Load is high, the output circuit 303 outputs the first level output signal Vᵣₛₜ₁. Because of strong driving capability of the multiplexer 301, the output voltage of the 2-level source driver 300 is pulled up to the first level output signal Vᵣₛₜ₁ in a time t₁. When the load signal Load is low, the output circuit 303 outputs the second level output signal V1 and the output voltage of the 2-level source driver 300 is pulled up to the second level output signal V1. During period B, the multiplexer 301 selects the second reference voltage Vᵣₛₜ₂ as the first level output signal according to the polarity signal POL. The D/A converter 127 converts the gray level signal to a corresponding gray level voltage V2. The gray level voltage V2 is the second level output signal during the period B. The output circuit 303 receives the first and second level output signals Vᵣₛₜ₂ and V2. When the load signal Load is high, the output circuit 303 outputs the first level output signal Vᵣₛₜ₂. The output voltage of the 2-level source driver 300 is pulled up to the first level output signal Vᵣₛₜ₂ in a time t₂. When the load signal Load is low, the output circuit 303 outputs the second level output signal Vᵣₛₜ₂ and the output voltage of the 2-level source driver 300 is pulled up to the second level output signal V2. Due to the 2-level source driver 300, time required to pull the output voltage to the second level output signal is significantly reduced, as is response time of a liquid crystal display, accordingly.

FIG. 4B is another exemplary output waveform of a 2-level source driver 300 according to an embodiment of the invention. In this case, a voltage of the first level output signal Vᵣₛₜ₁/Vᵣₛₜ₂ exceeds the second level output signal V1/V2. During periods A and B, the output voltage of the 2-level source driver 300 is respectively pulled to the first level output signal Vᵣₛₜ₁ and Vᵣₛₜ₂, followed by pulling back to the second level output signal V1 and V2. Similarly, due to the 2-level source driver 300, a response time of a liquid crystal display reduces significantly.

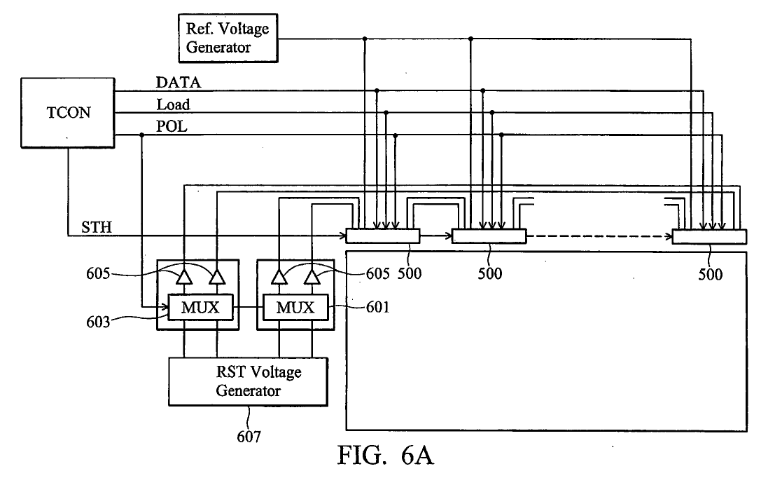

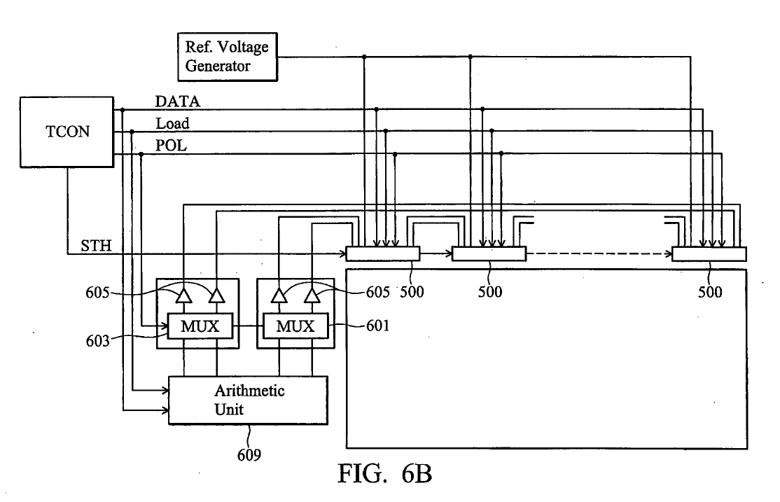

FIG. 6A is a schematic diagram of a liquid crystal display 600 comprising an overdrive system according to an embodiment of the invention. The overdrive system comprises a plurality of 2-level source drivers 500 connected in series, and first and second external multiplexers 601/603. Each 2-level source driver 500 is coupled to a pixel array and comprises, as shown in FIG. 5, a shift register, a register, a latch, a D/A converter, and an output circuit 303 inside the 2-level source driver 300. The output circuit 303 receives an output signal of the D/A converter and an external reference voltage and selects the output signal of the D/A converter or the external reference voltage as an overdrive output signal according to the load signal. The first and second external multiplexers 601/603 are respectively coupled to first and last 2-level source drivers 500. The first and second external multiplexers 601/603 both receive the external reference voltage and provide it to the first and last 2-level source drivers. As shown in FIG. 6A, the overdrive system may further comprise buffers 605 coupled between the first and second external multiplexers 601/603 and the first and last 2-level source drivers. The buffers 605 improve driving capability of the first and second external multiplexers 601/603. In addition, the overdrive system may further comprise a reference voltage generator 607 generating the external reference voltages and provide it to the first and second external multiplexers 601/603 as first and second reference voltages, Vᵣₛₜ₁ and Vᵣₛₜ₂. Furthermore, the first and second reference voltages, Vᵣₛₜ₁ and Vᵣₛₜ₂, respectively have fixed voltages.

FIG. 6B is a schematic diagram of a liquid crystal display comprising a variation of the overdrive system in FIG. 6A, differing in that the reference voltage generator 607 is replaced by an arithmetic unit 609. The arithmetic unit 609 receives the gray level signal Data and the load signal Load and dynamically generates the first and second reference voltages Vᵣₛₜ₁ and Vᵣₛₜ₂. In other words, the first and second reference voltages, Vᵣₛₜ₁ and Vᵣₛₜ₂, generated by the arithmetic unit 609 are varied according to the gray level signal Data.

While the invention has been described by way of example and in terms of preferred embodiment, it is to be understood that the invention is not limited thereto. To the contrary, it is intended to cover various modifications and would be apparent to those skilled in the art. Therefore, the scope of the appended claims should be accorded the broadest interpretation so as to encompass all such modifications.

What is claimed is:

1. A source driver for a liquid crystal display providing two-level output signals, the source driver comprising a multiplexer and providing a first level output signal and a second level output signal to a pixel array of the liquid crystal display, wherein the first level output signal is an external reference voltage, and the second level output signal is a gray level voltage corresponding to a gray level signal.

2. The source driver of claim 1, further comprising:
a shift register;
a register coupled to the shift register and receiving a gray level signal;
a latch coupled to the register and latching the gray level signal; and
a D/A converter coupled to the latch, receiving a polarity signal, a load signal and a gamma voltage and converting the gray level signal to a gray level voltage corresponding thereto.

3. The source driver of claim 2, wherein the multiplexer receiving an output signal of the D/A converter and an external reference voltage and selecting the output signal of the D/A converter or the external reference voltage as a second level output signal or a first level output signal according to the load signal.

4. The source driver of claim 2, wherein the multiplexer provides different external reference voltages as the first level output signal according to the polarity signal.

5. The source driver of claim 1, further comprising a buffer coupled to the multiplexer.

6. The source driver of claim 1, wherein a reference voltage generator is coupled to the multiplexer and generating the external reference voltage with a fixed voltage.

7. The source driver of claim 1, wherein an arithmetic unit is coupled to the multiplexer and generating the external reference voltage with a variable voltage.

8. The source driver of claim 7, wherein the external reference voltage is dynamically generated by the arithmetic unit according to the gray level signal.

9. An overdrive system for a liquid crystal display, comprising:
a plurality of source drivers connected in seriesand coupled to a liquid crystal pixel array; and
first and second external multiplexers respectively coupled to first and last source drivers;
wherein the source drivers provide a first level output signal and a second output signal to the liquid crystal pixel array, and the first level output signal is an external reference voltage, and the second level output signal is a gray level voltage corresponding to a gray level signal.

10. The overdrive system of claim 9, wherein each source driver comprising:
a shift register;
a register coupled to the shift register and receiving a gray level signal;
a latch coupled to the register and latching the gray level signal;
a D/A converter coupled to the latch, receiving a polarity signal, a load signal and a gamma voltage and converting the gray level signal to a gray level voltage corresponding thereto; and
an output circuit receiving an output signal of the D/A converter and an external reference voltage and outputting the output signal of the D/A converter and the external reference voltage as the second level output signal and the first level output signal according to the load signal.

11. The overdrive system of claim 9, further comprising buffers respectively coupled between the first and second external multiplexers and the first and last source drivers.

12. The overdrive system of claim 10, wherein the first and the second external multiplexers provide different external reference voltages as the first level output signal according to the polarity signal.

13. The overdrive system of claim 9, further comprising a reference voltage generator coupled to the first and second external multiplexers and generating the external reference voltage with a fixed voltage.

14. The overdrive system of claim 9, further comprising an arithmetic unit coupled to the first and second external multiplexers and generating the external reference voltage with a variable voltage.

15. The overdrive system of claim 14, wherein the external reference voltage is dynamically generated by the arithmetic unit according to the gray level signal.

16. A liquid crystal display comprising the overdrive system of claim 9.
